(19) United States
(12) Patent Application Publication
(10) Pub. No.: US 2024/0329200 A1
(43) Pub. Date: Oct. 3, 2024

(54) ANGLE COMPENSATION DEVICE AND METHOD, AND RADAR DEVICE INCLUDING THE SAME

(71) Applicant: HL KLEMOVE CORP., Incheon (KR)

(72) Inventor: Jong-Wun SUL, Incheon (KR)

(21) Appl. No.: 18/608,908

(22) Filed: Mar. 18, 2024

(30) Foreign Application Priority Data
Mar. 27, 2023 (KR) 10-2023-0039751

(51) Int. Cl. G01S 7/40; G01S 13/52; G01S 13/931

(52) U.S. Cl. CPC G01S 7/403; G01S 7/40; G01S 13/52; G01S 13/931

(57) ABSTRACT

An angle compensation device and method for a radar device may detect a stationary object around a host vehicle if the host vehicle is driving in a straight line, determine a relative speed of the stationary object with respect to the host vehicle and a driving speed of the host vehicle, determine a linear regression coefficient of a speed sensor error by calculating a difference between the relative speed of the stationary object and the driving speed of the host vehicle, determine an angle compensation value according to misalignment of the radar device using the linear regression coefficient, and compensate an angle of a target using the angle compensation value.

### CROSS REFERENCE TO RELATED APPLICATION

This application claims benefit from and priority to Korean Patent Application No. 10-2023-0039751, filed on Mar. 27, 2023, which is hereby incorporated by reference for all purposes as if fully set forth herein.

### TECHNICAL FIELD

The present disclosure generally relates to an angle compensation device and method for a radardevice. More specifically, embodiments of the present disclosure relate to a device and method for compensating an angle of a target using a linear characteristic of a speed sensor error, and a radar device including the same.

### BACKGROUND

A driver assistance system (DAS) may need to acquire accurate information related to one or more targets or objects around a vehicle. A plurality of vehicle sensors may be used to implement such a DAS function, and a vehicle radar device is used for the DAS as one of the plurality of vehicle sensors.

Meanwhile, a camera sensor, among vehicle sensors, has an advantage of being able to obtain accurate target information, but the use of the camera is limited depending on a climatic environment such as nighttime or fog.

However, a vehicle radar sensor can be widely used as a vehicle sensor in that there is relatively no limitation due to nighttime or weather conditions in comparison with the camera sensor.

A radar device mounted in or to the vehicle may transmit a radar signal, which is an electromagnetic wave having a specific frequency, receive a signal reflected from an object, and then process the reception signal (i.e. the rejected signal) to acquire information related to the object such as the location or speed information of the object.

A vehicle radar device may include one or more transmission antennas and one or more reception antennas, and may acquire target or object information such as an estimation angle (e.g. azimuth or elevation angle) of the target or object, distance, and relative speed from a synthesized signal of a transmission signal and a reception signal reflected from the target or object.

The radar device may be required to be mounted to or on a part of the vehicle so as to face a specific target direction.

For example, a front radar device is required to be mounted on the front of the vehicle to accurately orient the longitudinal direction of the vehicle.

However, due to some reasons such as errors in the mounting or assembling process of the radar device, there may occur a specific difference or error between a mounting direction of the radar device and a target direction. This case may be referred as misalignment of the radar device.

If the radar device is mounted in a misaligned state, an error may occur in the estimation angle of the target. In this case, inaccurate information related to objects may be generated, thereby causing a problem in performing the DAS function.

Therefore, in order to precisely detect the target, it is necessary to estimate the mounting misalignment angle of the radar device and compensate for the error of the estimated target angle.

Conventional methods for compensating mislignment of the radar device may take a lot of time to collect data of a plurality of objects, and need a lot of resource, time and calculation for estimating a mounting misalignment angle using the collected data.

Therefore, there is required a more accurate and simple method for determining the misalignment of the radar device and accurately compensate for target information.

It is with respect to these and other general considerations that the following embodiments have been described. Also, although relatively specific problems have been discussed, it should be understood that the embodiments should not be limited to solving the specific problems identified in the Background.

### SUMMARY

An object of some embodiments of the present disclosure may be to provide an angle compensation device and method capable of quickly and accurately determining the misalignment of a radar device, and a radar device including the same.

Another object of certain embodiments of the present disclosure may be to provide an angle compensation device and method capable of determining the misalignment of a radar device using linear characteristics of a speed sensor error and quickly and accurately compensating for the estimation angle of the target based on the determination, and a radar device including the same.

Still another object of some embodiments of the present disclosure may be to provide an angle compensation device and method capable of determining the mounting misalignment of a radar device by analyzing a speed sensor error by calculating a difference between a relative speed of a stationary object measured by radar and the speed of a host vehicle according to a linear regression equation, and a radar device including the same.

In accordance with an aspect of the present disclosure, there may be provided an angle compensation device including a stationary object detector configured to detect a stationary object, a straight-line driving determiner configured to determine whether a host vehicle is driving in a straight line, a relative speed determiner configured to determine a relative speed of the stationary object with respect to the host vehicle, a speed determiner configured to determine a driving speed of the host vehicle by using a sensing means provided in the host vehicle, a linear regression analyzer configured to, if the host vehicle is driving in a straight line, determine a speed sensor error defined as a difference between a relative speed of the stationary object and the driving speed of the host vehicle, and determine a linear regression coefficient of the speed sensor errors for estimation angles of a plurality of stationary objects, and an angle compensator configured to determine an angle compensation value according to misalignment of a radar device using the linear regression coefficient and compensate for an angle of a target using the angle compensation value.

In this case, the angle compensator may determine the angle compensation value if an absolute value of the linear regression coefficient is greater than or equal to a threshold value.

In addition, the angle compensator may determine the angle compensation value differently using a sign of the linear regression coefficient and the absolute value.

The speed sensor error may be determined as a difference between an absolute value of a velocity component in a driving direction of the host vehicle among relative velocity vectors of the stationary object and an absolute value of the driving speed of the host vehicle.

The linear regression analyzer may further determine a coefficient of determination representing reliability of the linear regression coefficient, and may determine the linear regression coefficient if the coefficient of determination is greater than or equal to a threshold coefficient of determination.

The estimation angle of the stationary object may be an estimated azimuth, and the angle compensation value may be a compensation value for the estimated azimuth of the target.

Alternatively, the estimation angle of the stationary object may be an estimated elevation angle, and the angle compensation value may be a compensation value for the estimated elevation angle of the target.

The linear regression analyzer may determine the linear regression coefficient if the number of detected stationary objects is greater than or equal to a threshold number.

In accordance with another aspect of the present disclosure, there may be provided an angle compensation method including determining whether a host vehicle drives in a straight line, detecting a stationary object around the host vehicle, determining a relative speed of the stationary object to the host vehicle, determining a driving speed of the host vehicle by using a sensing means provided in the host vehicle, determining, if the host vehicle is driving in a straight line, a speed sensor error defined as a difference between the relative speed of the stationary object and the driving speed of the host vehicle, determining a linear regression coefficient of the speed sensor errors for the estimation angles of a plurality of stationary objects, and determining an angle compensation value according to misalignment of a radar device using the linear regression coefficient, and compensating an angle of the target using the angle compensation value.

In accordance with another aspect of the present disclosure, there may be provided a radar device including an antenna unit including a transmission antenna unit including one or more transmission antennas and a receiving antenna unit including one or more receiving antennas, a transceiver configured to transmit a transmission signal through the transmission antenna unit and receive a reception signal through the receiving antenna unit, a signal processor configured to estimate an angle of a target by processing the transmission signal and the reception signal, and an angle compensation device configured to detect a stationary object around a host vehicle if the host vehicle is driving in a straight line, determine a relative speed of the stationary object and a driving speed of the host vehicle, determine a linear regression coefficient of a speed sensor error defined as a difference between the relative speed of the stationary object and the driving speed of the host vehicle, determine an angle compensation value according to a misalignment of a radar device using the linear regression coefficient, and compensate an angle of a target using the angle compensation value.

According to an embodiment of the present disclosure, it is possible to quickly and accurately determine a misalignment of an installation of a radar device.

In addition, according to an embodiment of the present disclosure, it is possible to determine a mounting misalignment of a radar device using a linear characteristic of a speed sensor error, and quickly and accurately compensate an estimation angle of a target based on the determination.

In addition, according to an embodiment of the present disclosure, it is possible to determine a mounting misalignment of a radar device by analyzing a speed sensor error defined as a difference between a relative speed of a stationary object measured by the radar device and a driving speed of a host vehicle according to a linear regression equation, and quickly and accurately compensate an estimation angle of a target based on the determination.

### BRIEF DESCRIPTION OF THE DRAWINGS

FIG. 1 illustrates a schematic configuration of a radar device according to an embodiment of the present disclosure.

FIG. 2 illustrates a configuration of an angle compensation device of a radar device according to an embodiment of the present disclosure.

FIG. 3 illustrates an exemplary operation of obtaining distance-velocity information of a target by a radar device according to an embodiment of the present disclosure.

FIG. 4A illustrates an exemplary case in which a radar device is correctly aligned in a host vehicle to show a relationship between a stationary object and the host vehicle, and FIG. 4B is a graph for showing a relationship between an estimated azimuth of the stationary object and the speed sensor error in the case in which the radar device is correctly aligned in the host vehicle.

FIG. 5A illustrates a relationship between a stationary object and a host vehicle when a radar device is misaligned, and FIG. 5B illustrates a relationship between an estimated azimuth of the stationary object and a speed sensor error when a radar device is misaligned.

FIGS. 6A to 6D show a relationship between an estimated azimuth of a stationary object and a speed sensor error for various mounting angles of a radar device according to embodiments of the present disclosure.

FIGS. 7A and 7B are graphs for illustrating a relationship between a coefficient of determination and a linear regression coefficient of linear regression analysis according to an embodiment of the present disclosure.

FIG. 8 is a flowchart for illustrating an angle compensation method according to an embodiment of the present disclosure.

FIG. 9 is a flowchart of an angle compensation method according to an embodiment of the present disclosure.

FIG. 10 illustrates an antenna unit of a radar device according to an embodiment of the present disclosure.

FIGS. 11A and 11B illustrate an arrangement structure of a transmission antenna and a reception antenna included in an antenna unit of a radar device and an arrangement of a virtual reception channel vector according to the arrangement structure according to an embodiment of the present disclosure.

FIG. 12 illustrates a hardware configuration of a radar device or an angle compensation device included in the radar device according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described the embodiments in detail with reference to the drawings.

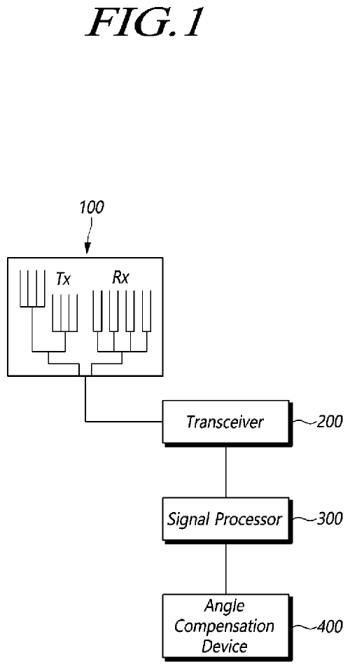

FIG. 1 illustrates a schematic configuration of a radar device according to an embodiment of the present disclosure.

A radar device according to an embodiment of the present disclosure may be, for example, but not limited, a multi-input multi-output (MIMO) type radar device including a plurality of transmission antennas.

Hereinafter, it will be described a structure in which the transmission antenna includes a first transmission antenna Tx1 and a second transmission antenna Tx2 as an example for illustration purposes only, but the present disclosure is not limited thereto.

A radar device according to an embodiment may include an antenna unit 100, a transceiver 200, a signal processor 300, and an angle compensation device 400.

The antenna unit 100 may include a transmission antenna unit including the first transmission antenna Tx1 and the second transmission antenna Tx2, and a reception antenna unit including a plurality of reception antennas.

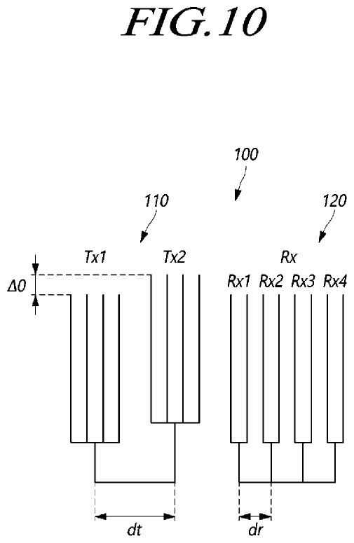

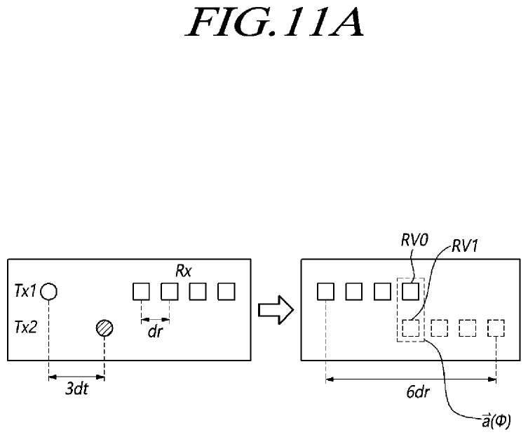

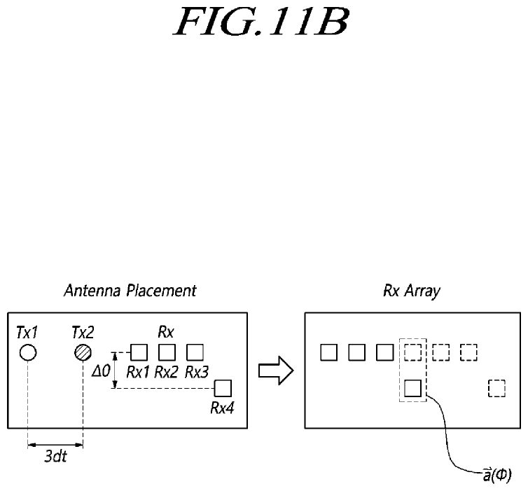

An exemplary specific configuration of the antenna unit 100 will be described in more detail below with reference to FIGS. 10 and 11.

The transceiver 200 may transmit a transmission signal through the transmission antenna unit and receive a reception signal through the reception antenna unit.

The transceiver 200 of the radar device according to the present embodiment may include a transmitter and a receiver. The transmitter may include an oscillation part configured to generate a transmission signal by supplying a signal to each transmission antenna. Such an oscillation part may include, for example, a voltage-controlled oscillator (VCO), an oscillator, and the like.

The receiver included in the transceiver 200 may include a low noise amplifier (LNA), a mixer, an amplifier, and a converter (analog-to-digital converter (ADC)). The low noise amplifier may be configured to low-noise-amplify a reflected signal received through the reception antenna. The mixer may be configured to mix the low-noise-amplified received signal. The amplifier may be configured to amplify the mixed received signal. The converter may be configured to digitally convert the amplified received signal to generate reception data.

As described above, the radar device according to the present embodiment may be implemented with a MIMO radar device that transmits a plurality of transmission signals simultaneously or in time division and receives the reception signals through a plurality of reception channels.

In general, radar sensor devices may be classified into a pulse type, a frequency modulation continuous wave (FMCW) type, and a frequency shift keying (FSK) type according to the type of signal used.

The FMCW radar device may utilize an up-chirp signal or a ramp signal, which is a signal of which frequency increases with time, and may calculate information on an object or target using a time difference between a transmission wave and a reception wave and a Doppler frequency (fd) shift.

Hereinafter, it will be described an FMCW-type radar device using a fast chirp signal or an up-chirp signal as an example, but the present disclosure is not limited thereto.

The signal processor 300 may determine a beat frequency or Doppler frequency fd from an intermediate frequency signal or a beat signal obtained by mixing (e.g., correlating) a transmission signal and a reception signal.

The Doppler frequency may be proportional to a distance to a target from which the received signal is reflected, and a velocity component or Doppler component of the target may be extracted based on a time change of the Doppler frequency or a phase change.

In addition, the signal processor 300 may generate a virtual channel vector as described below, and estimate an angle (e.g. an azimuth and/or elevation angle) of the target using the virtual channel vector.

That is, the signal processor 300 according to the present embodiment may obtain target information such as a distance or a range, a speed, and an angle of the target by processing the transmission signal and the reception signal.

The signal processor 300 of the radar device according to the present embodiment may also be referred as a radar signal processing device.

Specifically, the signal processor 300 of the radar device according to the present embodiment may include a first processor and a second processor for signal processing. For instance, the first processor may be a pre-processor for the second processor. The first processor may acquire transmission data and reception data, may control the oscillation part to generate a transmission signal based on the acquired transmission data, may synchronize the transmission data and the reception data, and may perform frequency conversion on the transmission data and the reception data.

The second processor may be a post-processor configured to perform actual processing using a pre-processing result of the first processor and may perform a constant false alarm rate (CFAR) operation, a tracking operation, a target selection operation, and the like based on the reception data subjected to the frequency conversion by the first processor. In addition, the second processor may calculate azimuth information. For instance, the azimuth information may be horizontal direction information of the target, and elevation angle information, which is vertical direction information of the target.

The first processor may perform frequency conversion after data-buffering acquired transmission data and acquired reception data in a unit sample size that is processable per cycle. The frequency conversion performed by the first processor may be implemented using a Fourier transform such as a fast Fourier transform (FFT), although not required.

The second processor may perform a second Fourier transform on a signal subjected to the first Fourier transform (FFT) by the first processor. The second Fourier transform may be, example, for a discrete Fourier transform (DFT) (hereinafter, referred to as “DFT”). For example, among DFTs, the second Fourier transform may be a chirp-discrete Fourier transform (chirp-DFT).

The second processor obtains as many frequency values as a number corresponding to a second Fourier transform length K through the second Fourier transform such as a chirp-DFT, determines a bit frequency having the greatest power for each chirp period based on the obtained frequency values, and acquires velocity information and distance information of an object based on the determined bit frequency, in order to detect the object.

The signal processor 300 may be expressed in another term such as a controller and may be implemented in the form of a digital signal processor (DSP).

The FMCW radar device may utilize an up-chirp signal or a ramp signal, which is a signal of which frequency increases with time, and may calculate information on an object using a time difference between a transmission wave and a reception wave and a Doppler frequency (fd) shift.

In addition, in the present disclosure, a distance to a target may be used as equivalent meaning to a range, and a velocity or a speed of the target may be used as equivalent meaning to a Doppler.

The angle compensation device 400 included in the radar device may be configured to detect a stationary object around a host vehicle if or while the host vehicle is driving or traveling in a straight line.

In addition, the angle compensation device 400 may determine a relative speed of the detected stationary object and a driving speed of the host vehicle, and may determine a linear regression coefficient of a speed sensor error. For example, the speed sensor error may be defined as a difference between the relative speed of the stationary object and the driving speed of the host vehicle.

That is, the angle compensation device 400 may perform linear regression analysis using an estimation angle of the detected stationary object as an independent variable and the speed sensor error as a dependent variable, and as a result, may determine the linear regression coefficient. In addition, the angle compensation device 400 may additionally determine a coefficient of determination representing reliability of the determined linear regression coefficient.

In addition, the angle compensation device 400 may determine an angle compensation value (e.g. an angle for compensating for misalignment of the radar device) according to mounting misalignment of the radar device using the determined linear regression coefficient, and compensate an angle of a target using the angle compensation value.

The angle compensation device 400 may be implemented by being integrated with the signal processor 300 of the radar device, or may be implemented as a separate processor or device from the signal processor. The angle compensation device 400, in one example, may be configured to implement functionality and/or process instructions for execution. For example, the angle compensation device 400 may be capable of processing instructions stored in memory. These instructions may define or otherwise control the operation of the radar device. For example, the angle compensation device 400 may be any suitable circuitry and/or electronic components, such as a microprocessor or a digital signal processor (DSP).

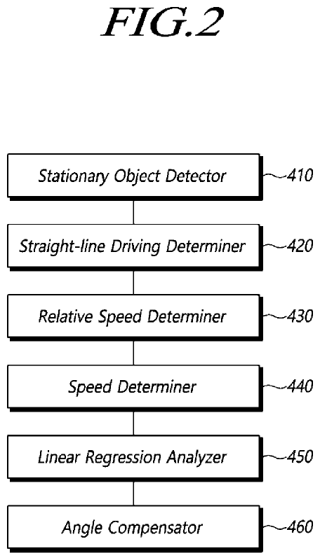

The detailed exemplary configuration of the angle compensation device 400 according to the present embodiment will be described in more detail below with reference to FIG. 2.

FIG. 2 illustrates a configuration of an angle compensation device of a radar device according to an embodiment of the present disclosure.

The angle compensation device 400 according to the present embodiment may include a stationary object detector 410, a straight line driving determiner 420, a relative speed determiner 430, a speed determiner 440, a linear regression analyzer 450, and an angle compensator 460.

The stationary object detector 410 may detect one or more targets around the host vehicle based on information associated with one or more sensors such as a radar sensor, a camera sensor, a lidar sensor, or an ultrasonic sensor mounted to or included in the vehicle.

In particular, the stationary object detector 410 may detect a stationary object among objects around the host vehicle.

In the present embodiment, a stationary object may be, for example, but not limited to, a road structure such as traffic lights and signs around a road, a clutter object such as a tunnel and a bridge, stopped or parked other vehicles, buildings, and pedestrians.

For example, in the case that a sign located near the host vehicle is detected using a camera sensor installed in the vehicle, the stationary object detector 410 may select the detected sign as a stationary object.

When determining whether an object is stationary by using radar signal processor, the stationary object detector 410 may determine an object as a stationary object if a velocity component of the detected object in the driving direction of the host vehicle is less than or equal to a threshold value.

For instance, the threshold value may be about 1.5 m/s, but not limited thereto.

As will be described below, if a radar device is misalignedly mounted, a slight error may occur when determining a stationary object using a radar signal.

Accordingly, the stationary object detector 410 may compare the velocity component of the detected object in the driving direction of the host vehicle with a predetermined threshold value in order to ensure the accuracy of determination of the stationary object.

The straight-line driving determiner 420 may determine whether the host vehicle is driving in a straight line or a straight direction, that is, whether of a straight driving.

For example, the straight-line driving determiner 420 may determine whether the host vehicle is driving in a straight line based on a yaw rate sensor, a steering angle sensor, and a vehicle speed sensor installed in the vehicle.

For example, the straight-line driving determiner 420 may determine that the host vehicle is driving in a straight line if the detected yaw rate is less than or equal to a predetermined threshold yaw rate value and the vehicle speed is greater than or equal to a predetermined threshold vehicle speed.

Alternatively or additionally, the straight-line driving determiner 420 may determine that the host vehicle is driving in a straight line if the measured steering angle, steering angular velocity, and/or steering angular acceleration is less than or equal to a specific or preset threshold value, and the vehicle speed is greater than or equal to a specific or preset threshold vehicle speed.

The relative speed determiner 430 may determine a relative speed of the stationary object with respect to the host vehicle.

As an example, the relative speed determiner 430 may determine the relative speed of the stationary object with respect to the host vehicle through radar signal analysis, but not limited thereto.

In general, among vehicle sensors, a radar device or system is used to precisely measure the speed of a target or object.

However, since the relative speed of a stationary object with respect to the host vehicle can be measured using other sensors such as a lidar sensor and a camera sensor, the relative speed determiner 430 according to the present embodiment may use any or all available sensor information to determine the relative speed of the stationary object with respect to the host vehicle.

The speed determiner 440 may determine a driving speed or a traveling speed of the host vehicle by using a sensing means provided in the host vehicle.

In this case, the sensing means provided in the host vehicle may be a vehicle speed sensor or a vehicle wheel speed sensor, but not limited thereto. Alternatively, the vehicle speed may be determined based on a navigation system installed in the vehicle, a Global Positioning System (GPS) device, and the like.

The linear regression analyzer 450 may determine a speed sensor error. For instance, the speed sensor error may be calculated based on a difference between the relative speed of a stationary object and the driving speed of the host vehicle.

Specifically, the linear regression analyzer 450 may determine linear regression coefficients of the speed sensor errors with respect to the estimation angles of a plurality of stationary objects.

That is, the linear regression analyzer 450 may perform linear regression analysis with the estimation angle of the detected stationary object as an independent variable and the speed sensor error defined as a difference between the relative speed of the stationary object and the driving speed of the host vehicle as a dependent variable.

The linear regression analyzer 450 may determine a linear regression coefficient as a result of the linear regression analysis, and may additionally determine a coefficient of determination indicating reliability of the linear regression coefficient.

In this case, the speed sensor error (SSE) may be a difference between an absolute value of a velocity component in the traveling direction of the host vehicle among the relative velocity vectors of the stationary object and an absolute value of the driving speed of the host vehicle.

In addition, the linear regression analyzer 450 may further determine a coefficient of determination representing reliability of the linear regression coefficient, and may determine the linear regression coefficient only if the coefficient of the determination is greater than or equal to a threshold coefficient of the determination.

In addition, the linear regression analyzer 450 may determine the coefficient of the determination and/or the linear regression coefficient if the number of the detected stationary objects is greater than or equal to a threshold number.

In the normal case in which the radar device is adequately or normally mounted on the vehicle, if the host vehicle travels in a straight line, the value of the velocity component in the driving direction of the host vehicle among the relative velocity vectors of the stationary object may have the same absolute value as the vehicle velocity and the sign (i.e. direction) is opposite.

In the normal case, the direction of the radar device of the vehicle may coincide with the driving direction of the host vehicle.

On the other hand, there may occur a misalignment case in which the vehicle's radar device is positioned to have a specific misalignment angle with respect to the driving direction of the host vehicle.

Such a misalignment case may be expressed as a tilt mounting case.

In the misalignment case, an absolute value of the velocity component in the driving direction of the host vehicle among the relative velocity vectors of the stationary object may be different from an absolute value of the velocity of the host vehicle.

Hereinafter, in the present specification, the absolute value of the velocity component in the driving direction of the host vehicle among the relative velocity vectors of the stationary object may be expressed as a relative speed value of the stationary object for convenience.

This phenomenon occurs due to the misalignment of the radar device, and the difference between the relative speed value of the stationary object and the speed value of the host vehicle, that is, the speed sensor error (SSE) may have a specific relationship with the estimation angle of the stationary object and the misalignment angle of the radar device.

The angle compensation device 400 according to the present embodiment may detect a misalignment of the radar device and compensate for an angle estimation value of the target by using a linear regression analysis result of a speed sensor error with respect to the estimation angle of the stationary object.

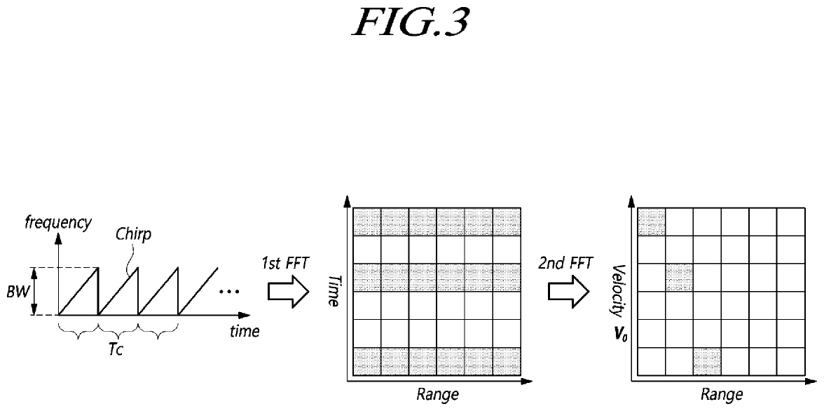

The linear regression analysis and the angle compensation method will be described in more detail below with reference to FIG. 3.

Meanwhile, the angle compensator 460 may determine an angle compensation value (i.e. a value for compensating an angle of the target) according to the misalignment of the radar device using the linear regression coefficient determined by the linear regression analyzer 450, and may compensate the angle of the target using the angle compensation value.

Specifically, the angle compensator 460 may determine the angle compensation value differently by using a sign of the linear regression coefficient and an absolute value of the linear regression coefficient.

For example, the estimation angle of the stationary object may be an estimated azimuth, and the angle compensation value may be a compensation value for the estimated azimuth of the target.

Alternatively, the estimation angle of the stationary object may be an estimated elevation angle, and the angle compensation value may be a compensation value for the estimated elevation angle of the target.

According to the present embodiment, the angle compensation device 400 may analyze the speed sensor error defined as the difference between the relative speed of the stationary object measured by the radar and the speed of the host vehicle according to the linear regression equation so as to determine mounting misalignment of the radar device.

In addition, to the angle compensation device 400 may quickly and accurately compensate for the estimation angle of the target by determining an angle estimation compensation value for the target based on the mounting misalignment angle of the radar device.

FIG. 3 illustrates an exemplary operation in which a radar device acquires range-velocity information of a target according to an embodiment of the present disclosure.

Referring to FIG. 3, the radar device according to the present embodiment may perform a first Fourier transform (FFT) on a fast time of a reception signal to obtain a time component according to a range. In addition, the radar device may perform a second Fourier transform on a slow time of the reception signal to compress a signal present at each range according to a velocity, thereby determining range-velocity information of a target.

More specifically, as shown at the left side of FIG. 3, the signal processor 300 may perform the first Fourier transform 1st FFT, which is a primary FFT, on a radar reception signal including a fast ramp or a fast chirp, thereby determining a range-time graph which corresponds to a time component according to a range.

Next, the signal processor 300 may perform the second Fourier transform 2nd FFT, which is a secondary Fourier transform, on a range-to-time component to determine range-velocity domain information indicating velocity information according to a range as shown at the right side of FIG. 3. The range-velocity domain information may be expressed as or on a range-Doppler map.

For example, as shown in FIG. 3, if a two-dimensional (2D) Fourier transform (FFT) is performed on a composite signal of the reception signal and a transmission signal, three grid areas may be represented as targets on the range-Doppler map, and the distance and speed of the target may be estimated from the range-Doppler map.

In addition, the signal processor 300 of the radar device according to the present embodiment may perform Fourier transform on the reception signal and extract the peaks of the reception signal using, for example, but not limited to, a constant false alarm rate (CFAR) algorithm or a local maximization method.

In addition, the signal processor 300 may generate a virtual channel vector for the reception signals, and may estimate angular information of the target, such as an azimuth angle and an elevation angle of the target, using the generated virtual channel vector.

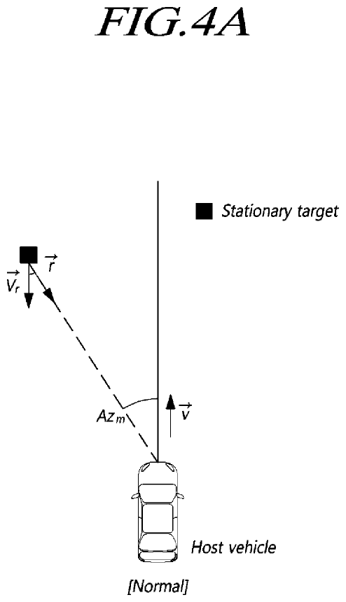

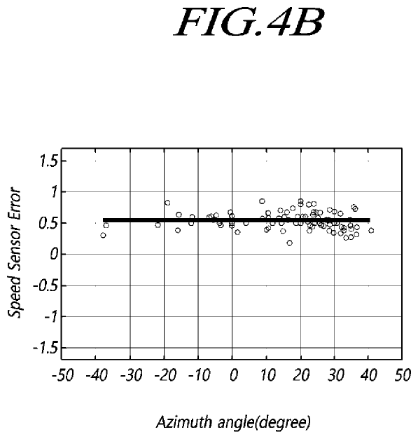

FIG. 4A illustrates an exemplary case in which a radar device is correctly aligned in a host vehicle to show a relationship between a stationary object and the host vehicle, and FIG. 4B is a graph for showing a relationship between an estimated azimuth of the stationary object and the speed sensor error in the case in which the radar device is correctly aligned in the host vehicle.

FIG. 4A illustrates a case in which the radar device is correctly mounted to the host vehicle to orient the direction of the host vehicle and the host vehicle travels in a straight line.

In this case, the radar device may measure the reflected reception wave reflected from an object, and may obtain information on a range or a distance of the object, a velocity vector (\vec{r}) toward the radar device, and an azimuth angle (Azₘ) as a horizontal angle.

The radar device may obtain the relative speed of the object with respect to the driving direction of the host vehicle by using a range (or a distance), angle information, and speed information of the object.

For instance, when \vec{r} is a velocity vector or range rate vector of the object in the direction of the radar device, the relative speed of the object with respect to the host vehicle (e.g., the velocity component \vec{vᵣ} of the object in the driving direction of the host vehicle) may be determined using

Equation 1 below.

$${{v}_{r}}^{⟶} = \frac{\vec{r}}{cos ( {Az}_{m} )} = - \vec{v} \qquad [ Equation 1 ]$$

Here, Azₘ is the measured azimuth of the object, and \vec{v} is a velocity vector of the host vehicle.

That is, in the normal case in which the radar device is normally or appropriately mounted to the host vehicle, the relative speed \vec{vᵣ} of the object to the host vehicle may have the same absolute value as the velocity vector \vec{v} of the host vehicle, but the sign of the object may be opposite to the sign of the velocity vector \vec{v} of the host vehicle.

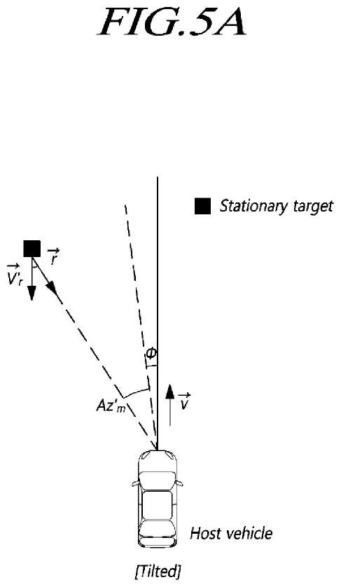

FIG. 5A illustrates an exemplary case in which a radar device is tilted or misaligned to the left by a tilt angle or misalignment angle φ from the driving direction of the host vehicle.

In this case illustrated in FIG. 5A, the azimuth of the object acquired by the radar device may be measured as Az′ₘ, which is different from the azimuth Azₘ measured in the normal case illustrated in FIG. 4A.

Therefore, in the case in which the radar device is misaligned, the relative speed of the object to the host vehicle, that is, a velocity component \vec{vᵣ} of the object in the driving direction of the host vehicle, may be determined using Equation 2 below.

$${{v}_{r}}^{⟶ ′} = \frac{\vec{r}}{cos ( {Az}_{m} ′ )} \neq - \vec{v} \qquad [ Equation 2 ]$$

As above, if the radar device is misalignedly mounted to or on the vehicle, an absolute value of the relative speed \vec{vᵣ}′ of the object may be different from an absolute value of the velocity vector \vec{v} of the host vehicle, and the difference between these two absolute values may be defined as a speed sensor error.

That is, in this specification, the speed sensor error SSE may be defined as a difference between the absolute value of the velocity component \vec{vᵣ}′ in the driving direction of the host vehicle among the relative velocity vectors of the stationary object and the absolute value of the velocity vector \vec{v} of the host vehicle.

This can be expressed as Equation 3 below.

$$SSE = \vert {v}_{r}^{′} \vert - \vert v \vert \qquad [ Equation 3 ]$$

As in Equations 2 and 3 above, the larger the difference between the estimated azimuth Az′ₘ of the stationary object in the case of the misalignment of the radar device and the actual estimated azimuth Azₘ of the stationary object in the normal case, the larger the value of the speed sensor error.

As the misalignment angle or tilt angle φ of the radar device increases, the difference between Az′ₘ and Azₘ increases.

Accordingly, as the misalignment angle or tilt angle φ of the radar device increases, the value of the speed sensor error also increases.

In addition, according to Equation 2, even if the misalignment angle or tilt angle φ of the radar device is the same, the value of the speed sensor error increases as the value of the estimated azimuth Azₘ or Az′ₘ of the stationary object increases.

In this way, the speed sensor error SSE may have a specific relationship with the estimated azimuth angle (Azₘ or Az′ₘ) of the stationary object and the misalignment angle or tilt angle φ of the radar device.

Therefore, in this embodiment, the misalignment angle or tilt angle φ of the radar device may be determined by analyzing the relationship between the estimated azimuth angle and the speed sensor error with respect to a plurality of stationary objects by a linear regression method.

FIG. 4B illustrates a relationship between an estimated azimuth angle of a plurality of stationary objects and a speed sensor error in a normal case in which a radar device is normally mounted or properly aligned to or on the vehicle.

As shown in FIG. 4B, if the radar device is normally or appropriately mounted to or on a vehicle, the speed sensor error may have a constant value for a plurality of stationary objects having different azimuth angles.

In the normal case, the speed sensor error for a plurality of stationary objects may be determined using Equation 4 below, and in the example of FIG. 4B, β₀ has a value of about 0.6.

$$SSE = \vert {v}_{r} \vert - \vert v \vert = \frac{r}{cos ( {Az}_{m} )} - \vert v \vert \approx {β}_{0} ( Normal Case ) \qquad [ Equation 4 ]$$

FIG. 4B represents the speed sensor error SSE for 100 stationary objects with respect to the estimation angle (e.g. estimated azimuth) of each stationary object.

In the normal case in which the radar device is normally mounted to the vehicle, a correlation coefficient between the speed sensor error SSE and the estimation angle of the object, for example, the linear regression coefficient or a slope β1 of the linear regression equation, may converges to zero.

That is, if linear regression analysis is performed with the azimuth angle of a stationary object as an independent variable (x) and the speed sensor error as a dependent variable (y), the linear regression coefficient β1 has a value close to 0 in the normal case.

In the present disclosure, a correlation coefficient, a linear regression coefficient, or a slope of a linear regression equation and the like may be used as equivalent meanings.

Meanwhile, in the normal case, β0 may be an offset error between a vehicle speed sensor and a radar sensor.

That is, a specific offset may exist between the zero-point velocity value of the vehicle speed sensor and the zero-point velocity value of the radar sensor, and this offset may become a y-intercept value of the linear regression equation.

Meanwhile, FIG. 5B illustrates a relationship between an estimated azimuth angle of a plurality of stationary objects and a speed sensor error in the case that the radar device is misalignedly mounted to the vehicle.

As shown in FIG. 5B, if the radar device is abnormally or incorrectly mounted to the vehicle while having a constant tilt angle or misalignment angle with respect to the driving direction of the vehicle, the speed sensor error may change while having a specific linear relationship with respect to a plurality of stationary objects having different azimuth angles.

In the case of the misalignment case, the speed sensor error for a plurality of stationary objects may be determined using Equation 5 below.

$$SSE = \vert {v}_{r}^{′} \vert - \vert v \vert = \frac{r}{cos ( {Az}_{m}^{′} )} - \vert v \vert \approx {β}_{1} x + {β}_{0} ( Tilted Case ) \qquad [ Equation 5 ]$$

FIG. 5B represents the speed sensor error SSE for 100 stationary objects with respect to the estimation angle (e.g. estimated azimuth) of each stationary object if the misalignment angle φ is about 3 degrees to the left.

In the case that the radar device is not normally mounted or is misalignedly mounted to the vehicle, the linear regression coefficient of the speed sensor error SSE or the slope of the linear regression equation with respect to the estimation angle of the object may become β1.

That is, if linear regression analysis is performed with the azimuth of a stationary object as an independent variable (x) and the speed sensor error as the dependent variable (y), when the misalignment angle φ is −3°, the linear regression coefficient β1 may have a constant positive value other than zero.

In this case, the y-intercept of the linear regression equation may be about 0.6, which may be an offset error between the vehicle speed sensor and the radar sensor.

The angle compensation device 400 according to the present disclosure may use an ordinary least square method or a least loss function method for linear regression analysis of a speed sensor error, however is not limited thereto.

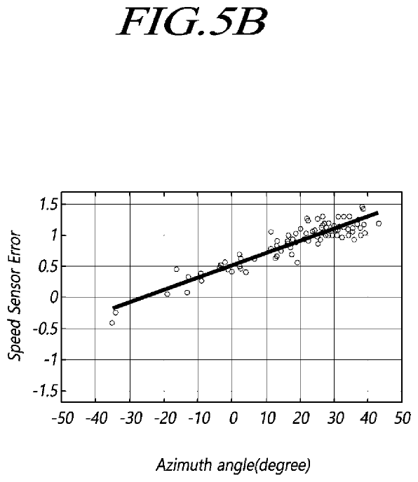

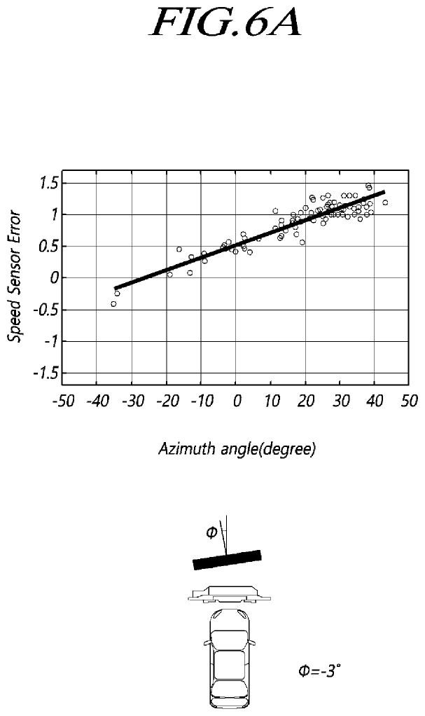

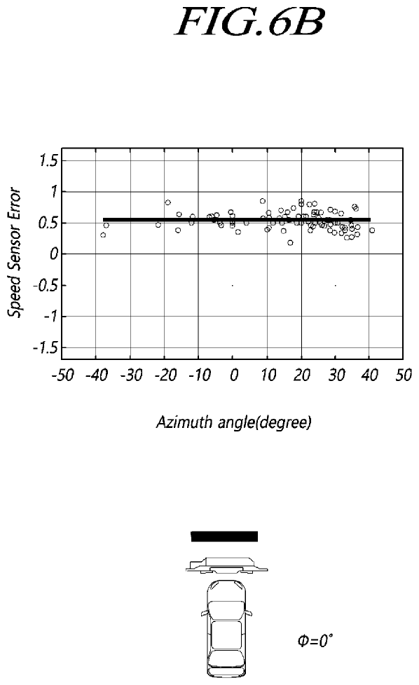

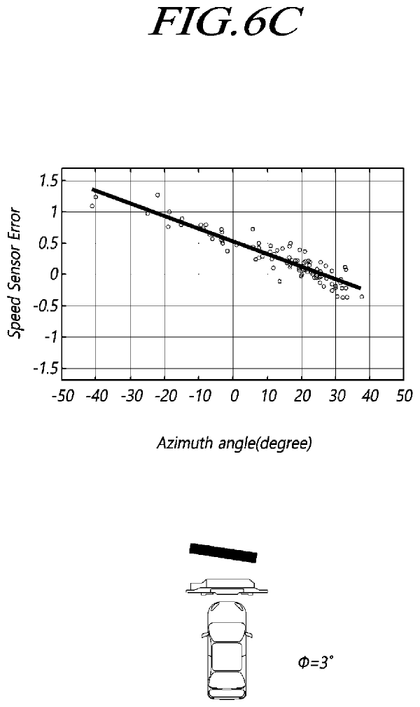

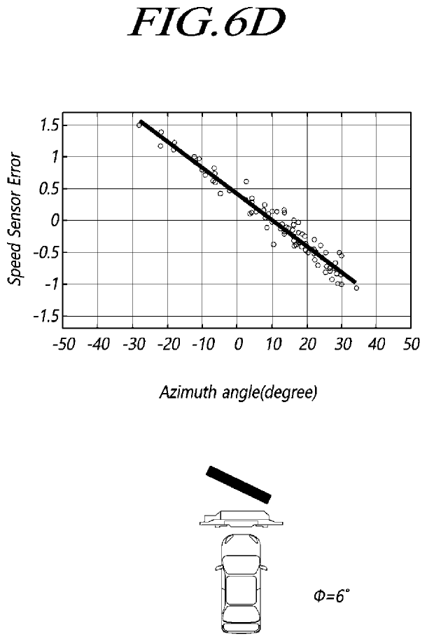

FIGS. 6A to 6D illustrate a relationship between the estimated azimuth of a stationary object and the speed sensor error for various mounting angles (i.e., misalignment angles) of the radar device.

FIGS. 6A to 6D illustrate results of linear regression analysis in cases that misalignment angles φ are −3°, 0°, 3°, and 6°, respectively.

That is, FIGS. 6A to 6D represent graphs in which the speed sensor error SSE of 100 objects detected by the radar device is mapped with respect to the estimation angle (azimuth) of each stationary object according to the mounting angle (i.e., misalignment angle).

If the radar device is misaligned to the left (for example, FIG. 6A), the linear regression coefficient β1 may have a positive value.

In addition, if the radar device is misaligned or tilted to the right (for instance, FIGS. 6C and 6D), the linear regression coefficient 31 may have a negative value.

In addition, as the misalignment angle φ increases, the absolute value of the linear regression coefficient β1 may also increase.

Therefore, the angle compensation device 400 according to the present disclosure may determine the value (e.g., an absolute value and sign) of the linear regression coefficient β1 of the speed sensor error SSE for the estimated azimuth (Az′ₘ) for a specific number or more of stationary objects, and may compensate the estimated azimuth of the target based on the value of the linear regression coefficient β1 of the speed sensor error SSE.

For example, as shown in FIG. 6B, if the linear regression coefficient β1 of the speed sensor error SSE has a positive value and is included in a first range, the angle compensation device 400 may determine the angle compensation value as a first compensation value ΔAzm1, and may determine an angle value obtained by subtracting the first compensation value ΔAzm1 from the estimation angle value Azmt′ of an estimated target as a final angle of the target.

Alternatively, as shown in FIG. 6C, if the linear regression coefficient β1 of the speed sensor error SSE has a negative value and is included in a second range, the angle compensation device 400 may determine the angle compensation value as a second compensation value ΔAzm2, and may determine an angle value obtained by adding the second compensation value ΔAzm2 to the estimation angle value Azmt′ of the estimated target as a final angle of the target.

In addition, as shown in FIG. 6D, if the linear regression coefficient β1 of the speed sensor error SSE has a negative value and is included in a third range, the angle compensation device 400 may determine the angle compensation value as a third compensation value ΔAzm3, and may determine an angle value obtained by adding the third compensation value ΔAzm3 to the estimation angle value Azmt′ of the estimated target as a final angle of the target.

In those cases, the first to third angle compensation values ΔAzm1, ΔAzm2 and ΔAzm3 may be determined differently according to an absolute value and sign of the linear regression coefficient β1 of the speed sensor error SSE.

In addition, the target angle compensation using the angle compensation value may be performed in stages for each radar signal processing cycle or scan period.

For example, if the misalignment angle is 3 degrees, the target angle may be continuously compensated for a plurality of scan periods by using a unit angle compensation value of 0.1 degrees per radar signal processing cycle or scan period.

That is, the target angle may be compensated step-by-step during a plurality of scan periods in order to solve a problem caused by rapid change in target information.

In addition, the angle compensation device 400 according to the present disclosure may calculate the angle compensation value if the absolute value of the determined linear regression coefficient is greater than or equal to a threshold value.

For example, the angle compensation device 400 according to the present disclosure may perform misalignment determination and angle compensation only if the absolute value of the linear regression coefficient β1 of the speed sensor error SSE is greater than or equal to a predetermined threshold value βₜₕ.

Accordingly, the angle compensation may be performed only if there is a significant degree of misalignment (e.g. if an angle of misalignment is greater than a preset angle), thereby reducing computational load according to the angle compensation.

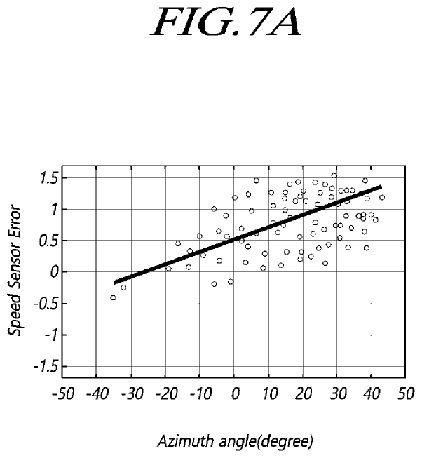

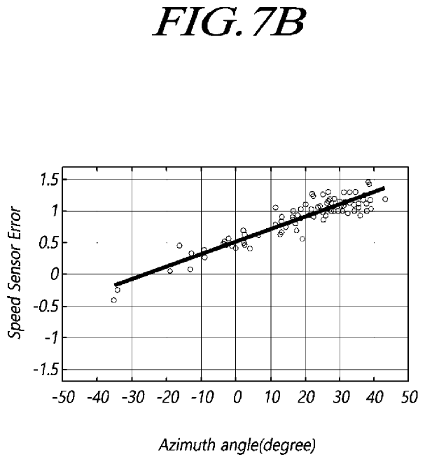

Meanwhile, the angle compensation device 400 according to the present disclosure may further determine a coefficient of determination representing reliability of the linear regression coefficient, and may determine the linear regression coefficient if the coefficient of determination representing the reliability of the linear regression coefficient is greater than or equal to a threshold coefficient of determination. This will be described in more detail below with reference to FIGS. 7A and 7B.

FIGS. 7A and 7B illustrate a relationship between a coefficient of determination and a linear regression coefficient of linear regression analysis according to an embodiment of the present disclosure.

The linear regression analyzer 450 of the angle compensation device 400 according to an embodiment of the present disclosure may determine a coefficient of determination representing the reliability of the linear regression coefficient.

The coefficient of determination may be an index indicating whether a linear regression equation accurately reflects the calculated speed sensor errors.

For example, the coefficient of determination may have a value of 0 to 1. The coefficient of determination may be closer to 1 as the speed sensor errors are well matched to the determined linear regression equation.

FIG. 7A is a graph showing a case that the coefficient of determination has a first coefficient of determination of a relatively low value, and FIG. 7B is a graph showing a case that the coefficient of determination has a second coefficient of determination of a relatively high value.

The linear regression coefficient of the exemplary case of FIG. 7A may be determined similar to that of the exemplary case of FIG. 7B, but since the coefficient of determination of the exemplary case of FIG. 7A is relatively low, the reliability of the linear regression equation of the exemplary case of FIG. 7A may be relatively low.

Meanwhile, the coefficient of determination of the exemplary case of FIG. 7B is relatively high, so the accuracy or reliability of the linear regression equation the exemplary case of FIG. 7B may be relatively high.

Therefore, the linear regression analyzer 450 of the angle compensation device 400 according to an embodiment of the present disclosure may perform misalignment determination, linear regression coefficient determination, and angle compensation only if the coefficient of determination is greater than or equal to a threshold coefficient of determination.

If the coefficient of determination is less than or equal to a specific or preset threshold coefficient of determination, the angle compensation device 400 may not perform subsequent steps because it is difficult to accurately determine linear regression analysis.

The threshold coefficient of determination may be preset to, for example, but not limited to 0.65.

The coefficient of determination may be determined based on a square value of a difference between the calculated value of the determined linear regression equation and the actually measured value of the speed sensor error.

Compared with the conventional technology for determining misalignment of a radar device based on hundreds/thousands of object information, the angle compensation device 400 according to the present embodiment may simply and accurately determine the misalignment of the radar device and compensate for the target angle based on the linear regression characteristics of the speed sensor error with less resources.

In addition, according to some embodiments of the present disclosure, the angle compensation device 400 may need to consider only the linearity of the speed sensor error of a stationary object is considered without a wheel speed sensor bias error.

In addition, certain embodiments of the present disclosure may perform accurate misalignment determination and angle compensation using only a small number of stationary objects in a partial angular range without using a large number of objects in a wide angular range.

In the above description, it has been described an example of the linear regression analysis with the azimuth angle of a stationary object as an independent variable, and a horizontal misalignment determination of the radar device and an azimuth compensation of a target based thereon, but the present disclosure is not limited thereto.

As another example, a linear regression analysis may be performed with an elevation angle of a stationary object as an independent variable and a speed sensor error as a dependent variable, and a vertical misalignment determination of the radar device and an elevation angle compensation of the target based thereon.

It will be described examples of the measurement of the elevation angle of a stationary object, the determination of vertical misalignment using the same, and the compensation of the elevation angle of the target in more detail with reference to FIGS. 10 and 11.

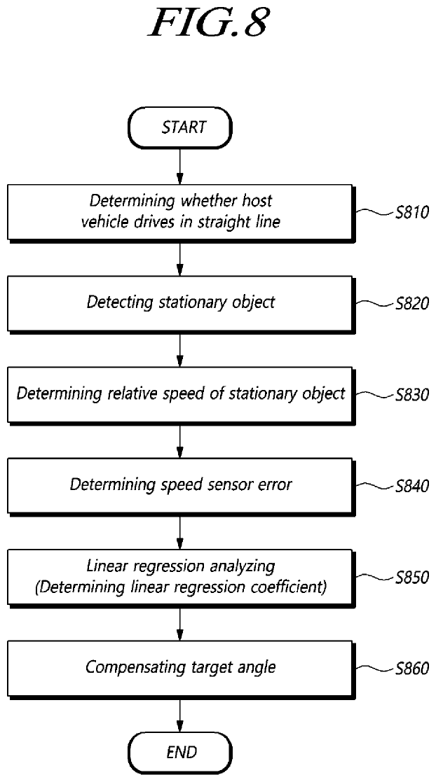

FIG. 8 is a flowchart for illustrating an angle compensation method according to an embodiment of the present disclosure.

An angle compensation method according to an embodiment may include one or more steps of determining whether a host vehicle is driving in a straight line (step S810), detecting a stationary object (step S820), and determining a relative speed of the stationary object with respect to the host vehicle (step S830), determining a speed sensor error (step S840), determining a linear regression coefficient (step S850), and compensating for a target angle (step S860).

In step S810 of determining whether the vehicle is driving in a straight line, an angle compensation device may determine whether the host vehicle is driving in a straight line based on, for example, but not limited to, a yaw rate, a steering angle, and a vehicle speed which may be sensed by a yaw rate sensor, a steering angle sensor, and a vehicle speed sensor provided in the host vehicle.

In step S820 of detecting a stationary object, the angle compensation device may identify a stationary object among objects detected around the vehicle based on sensor information generated by one or more sensors such as a radar sensor, a camera sensor, a LIDAR sensor, or an ultrasonic sensor provided in the host vehicle.

In step S830 of determining the relative speed of the stationary object, the angle compensation device may determine the relative speed of the stationary object, detected at step S820, with respect to the host vehicle.

For instance, the relative speed of the stationary object may mean a component in the driving direction of the host vehicle among relative velocity vectors toward the radar device.

In step S840 of determining the speed sensor error, the angle compensation device may determine the speed sensor error SSE. For example, the speed sensor error SSE may be calculated by a difference between an absolute value of a relative speed of the stationary object with respect to the host vehicle and an absolute value of driving speed of the host vehicle.

In step S850 of determining linear regression coefficients, the angle compensation device may determine linear regression coefficients of the speed sensor errors for estimation angles of a plurality of stationary objects determined at step S840.

Specifically, the angle compensation device may perform a linear regression analysis using the estimation angle of the detected stationary object as an independent variable and the speed sensor error defined as the difference between the relative speed of the stationary object with respect to the host vehicle and the driving speed of the host vehicle as a dependent variable.

In addition, the angle compensation device may further determine a coefficient of determination representing reliability of the linear regression coefficient, and determine the linear regression coefficient only if the coefficient of determination is greater than or equal to a threshold coefficient of determination.

In addition, the angle compensation device may determine the coefficient of determination and/or the linear regression coefficient if the number of the detected stationary objects is greater than or equal to a threshold number.

The threshold number may be preset to, for example, but not limited to, 100.

In step S860 of compensating the target angle, the angle compensation device may determine an angle compensation value (e.g. a value for compensating an angle of the target) according to the misalignment of the radar device using the linear regression coefficient determined at step S850, and compensate the angle of the target using the angle compensation value.

The angle compensation device may differently determine the angle compensation value depending on a sign of the linear regression coefficient and an absolute value of the linear regression coefficient.

In this case, the estimation angle of the stationary object may be an estimated azimuth, and the angle compensation value may be a compensation value for the estimated azimuth of the target.

Alternatively, the estimation angle of the stationary object may be an estimated elevation angle, and the angle compensation value may be a compensation value for the estimated elevation angle of the target.

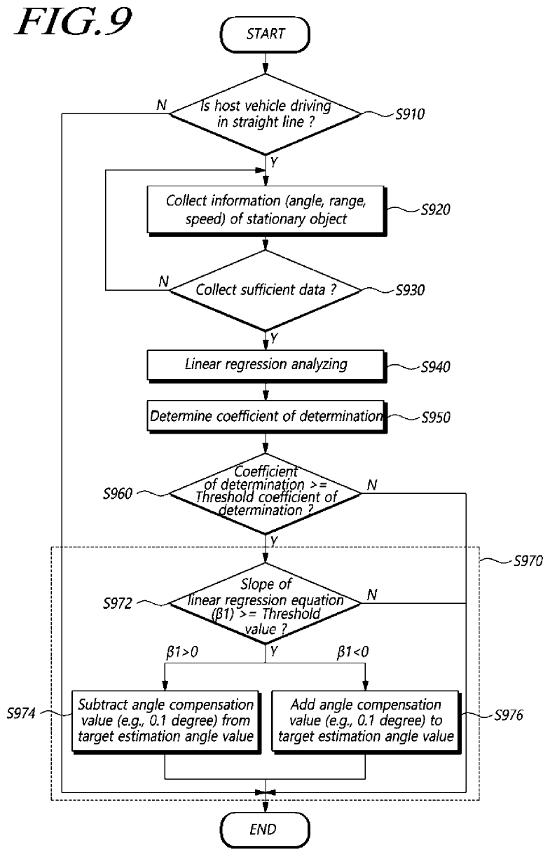

FIG. 9 is a flowchart of an angle compensation method according to an embodiment of the present disclosure.

In an angle compensation method according to an embodiment, an angle compensating device may first determine whether the host vehicle is traveling in a straight line based on, for example, but not limited to, a yaw rate value, a vehicle speed value of the vehicle, and the like. (step S910)

Next, the angle compensation device may acquire or collect information (e.g. azimuth, range, speed, etc.) of a predetermined number or more of stationary objects by using a vehicle sensor such as a radar sensor, lidar (Light Detection and Ranging) sensor, or image sensor (step S920).

The angle compensation device may determine whether the number of stationary objects included in the stationary object information acquired by the angle compensation device is equal to or greater than a threshold number (step S930).

If the number of stationary objects included in the stationary object information acquired by the angle compensation device is equal to or more than the threshold number, the angle compensation device may perform linear regression analysis (step S940).

Specifically, the angle compensation device may perform the linear regression analysis using an estimation angle (e.g. an estimated azimuth) of a stationary object as an independent variable and a speed sensor error SSE as a dependent variable.

In this case, the speed sensor error SSE may be defined as a difference between an absolute value of the velocity component in the driving direction of the host vehicle among the relative velocity vectors of the stationary object and an absolute value of the driving speed of the host vehicle.

The angle compensation device may determine a coefficient of determination through the linear regression analysis performed at step S940 (step S950).

The angle compensation device may determine whether the determined coefficient of determination is greater than or equal to a threshold coefficient of determination (step S960), and may perform auto-alignment or angle compensation in such as case (step S970).

In step S970 of performing the auto-alignment or angle compensation, the angle compensation device may determine a slope of the analyzed linear regression equation (e.g. a linear regression coefficient (1) and determine whether the linear regression coefficient β1 is equal to or greater than a predetermined threshold value. (step S972)

When it is determined that the linear regression coefficient β1 is equal to or greater than the threshold value, the angle compensation device may determine the angle compensation value as a negative value if the linear regression coefficient β1 has a positive sign.

In this case, the angle compensation device may determine a final target angle by subtracting the angle compensation value from the estimation angle (e.g. an estimated azimuth) of the target (step S974).

However, if the linear regression coefficient β1 has a negative sign, the angle compensation device may determine the angle compensation value as a positive value, and determine the final target angle by adding the angle compensation value to the estimation target angle (e.g. an estimated azimuth) (step S976).

In the above, it has been described an example of a linear regression analysis using the azimuth angle of a stationary object as an independent variable, and a horizontal direction misalignment determination of the radar device and a compensation of the azimuth angle of the target, but the present disclosure is not limited thereto.

As another example, there may be performed the linear regression analysis with an elevation angle of a stationary object as an independent variable and the speed sensor error as a dependent variable, and a vertical misalignment determination of the radar device and an elevation angle compensation of the target may be performed based on the linear regression analysis.

Hereinafter, it will be described the configuration of a radar device for such an elevation angle compensation.

FIG. 10 illustrates an antenna unit of a radar device according to an embodiment of the present disclosure.

An antenna unit 100 of the radar device configured to measure an elevation angle according to the present embodiment may include a transmission antenna unit 110 including Nt transmission antennas and a reception antenna unit 120 including Nr reception antennas.

As an example, FIG. 10 illustrates that the transmission antenna unit 110 includes two transmission antennas (Nt is 2) and the reception antenna unit 120 includes four reception antennas (Nr is 4).

Specifically, in the exemplary embodiment of FIG. 10, the antenna unit 100 may include two transmission antennas Tx1 and Tx2 and four reception antennas Rx1, Rx2, Rx3 and Rx4. The transmission antennas Tx1 and Tx2 may be spaced apart from each other by a predetermined offset distance ΔO in a vertical direction, and a plurality of reception antennas Rx1, Rx2, Rx3 and Rx4 may all have the same vertical position.

Alternatively, as shown in FIG. 11B, one of the reception antennas may be arranged to be offset in the vertical direction.

Each of the transmission antenna and the reception antenna may have a structure in which two, four, or six array antennas have one feed point and extend to one side, but the present disclosure is not limited thereto.

Each array antenna constituting the transmission antenna and the reception antenna may include a plurality of elements or patches connected to an output line of a divider and may extend in an upper direction (e.g. an upper direction of a vertical direction) from a starting point such as a feed in port connected to a chip including a controller or an input port of the divider.

In addition, the two transmission antennas Tx1 and Tx2 constituting the transmission antenna unit may be spaced apart from each other by a horizontal distance dt in a horizontal direction perpendicular to an extending direction of each array antenna. In this case, the horizontal distance dt may be a distance of ½ of a wavelength of a transmission signal (0.5λ).

In this case, four reception antennas Rx1 to Rx4 constituting the reception antenna unit may also be disposed apart from each other by a horizontal distance dr in the horizontal direction.

In this case, the horizontal distances dt and dr are set to the distance of ½ of the wavelength of the transmission signal (0.5λ) in order to remove angle ambiguity caused by a grating lobe.

That is, since a distance between the reception antennas is greater than or equal to the distance of ½ of the wavelength of the transmission signal (0.5λ), the grating lobe may occur. The horizontal distance between the reception antennas is set to 0.5λ, and pieces of angle information extracted from channels of the reception antennas are compared and compensated for, thereby reducing or minimizing the angle ambiguity of angle measurement caused by the grating lobe.

In addition, as shown in FIG. 10, since the two transmission antennas Tx1 and Tx2 are offset by the certain offset distance ΔO in the vertical direction, a first reception signal transmitted from the transmission antenna Tx1 and received by the reception antenna and a second reception signal transmitted from the transmission antenna Tx2 and received by the reception antenna may have a phase difference according to a vertical offset.

In addition, a first transmission signal and a second transmission signal having orthogonality to each other may be simultaneously transmitted through the first transmission antenna TX1 and the second transmission antenna TX2. Therefore, a target distance to a target may be

determined using a time difference between a transmission time and a reception time, and horizontal information or vertical information (e.g., elevation angle) of the target may be determined using a phase difference between the first and second transmission signals and the first and second reception signals.

In the radar device according to the present embodiment, radar signals transmitted or received from the transmission antenna or reception antenna offset in the horizontal direction may be modulated and used through different modulation methods.

Meanwhile, in the radar device according to the present embodiment, due to a virtual reception antenna-forming unit, a reception end may have a reception array structure in which a plurality of reception antennas are actually present, and also, a plurality of virtual reception antennas are virtually present.

As described above, an antenna structure in which a plurality of virtual reception antennas are further virtually present at the reception end may be expressed as an “antenna structure having a virtual aperture structure.”

For example, in an antenna structure of FIG. 10, during a certain detection period (or frame or the like), the first transmission signal and the second transmission signal having orthogonality to each other are simultaneously transmitted through the first transmission antenna TX1 and the second transmission antenna TX2.

Meanwhile, since the first transmission antenna TX1 and the second transmission antenna TX2, which respectively transmit the first transmission signal and the second transmission signal, are spaced apart from each other by the horizontal distance dt in the horizontal direction and the offset distance ΔO in the vertical direction, the reception antenna receiving a reflected signal reflected from an object has the same effect as that when reflected signals of the first transmission signal and the second transmission signal are received by being shifted by the horizontal distance dt in the horizontal direction and the offset distance ΔO in the vertical direction.

In this case, as a concept distinguishable from an actual reception antenna, a reception antenna, which is virtually present due to horizontal and vertical separation between transmission antennas which simultaneously transmit signals, may be expressed as a virtual reception antenna.

In addition, a vector from a specific reference point to each virtual reception antenna may be expressed as a virtual channel vector.

FIG. 11 illustrates an arrangement structure of a transmission antenna and a reception antenna included in an antenna unit of a radar device according to an embodiment, and arrangement of a virtual reception channel vector according to the arrangement structure according to an embodiment of the present disclosure.

In FIG. 11, the transmission antenna is illustrated as a circle and the reception antenna is illustrated as a rectangle. In addition, the actual antenna is indicated by a solid line, and the virtual reception antenna is indicated by a dotted line.

In an embodiment of FIG. 11A, two transmission antennas Tx1 and Tx2 are disposed apart from each other by a horizontal distance 3dt in a horizontal direction and an offset distance ΔO in a vertical direction. In addition, four reception antennas have the same vertical position as the transmission antenna Tx1 and are disposed apart from each other by a horizontal distance dr.

In this case, four virtual reception antennas formed at a reception end are formed to be offset from the four actual reception antennas by the horizontal distance 3dt in the horizontal direction and the offset distance ΔO in the vertical direction.

In the embodiment of FIG. 11A, a radar device according to the present embodiment includes the plurality of transmission antennas and the plurality of reception antennas, and one of the plurality of transmission antennas is disposed apart from the other of the plurality of transmission antennas by the offset distance in the vertical direction. In addition, different transmission signals having orthogonality are transmitted from the transmission antennas.

Accordingly, a composite signal of a reception signal and a transmission signal reflected from a target may be divided in the vertical direction, and thus vertical information of the target may be determined.

In addition, an aperture of the reception antenna may be expanded by the plurality of virtual reception antennas formed at a reception side, thereby improving resolution.

A size of the aperture of the reception antenna may be defined by a distance between the reception antennas disposed at both ends of the reception side.

Accordingly, in the case of FIG. 11A, the size of the aperture of the reception antenna may be extended to a horizontal distance 6dr.

Therefore, as shown in FIG. 11A, the detection resolution may be improved by using aperture expansion through the virtual reception antenna.

FIG. 11B illustrates an embodiment in which reception antenna is vertically offset.

In the embodiment of FIG. 11B, two transmission antennas Tx1 and Tx2 are spaced apart from each other by a horizontal distance 3dt in a horizontal direction and are not offset in a vertical direction. On the other hand, among four reception antennas, one reception antenna Rx4 is spaced apart from the other three reception antennas Rx1 to Rx3 by an offset distance ΔO in the vertical direction. In other words, one reception antenna Rx4 has a different vertical position from the other three reception antennas Rx1 to Rx3, which has the same vertical position, by an offset distance ΔO.

That is, the three reception antennas Rx1 to Rx3 are disposed at the same vertical position as the two transmission antennas Tx1 and Tx2, and only one reception antenna Rx4 is disposed to be offset by the offset distance ΔO in the vertical direction. A distance between the reception antennas in the horizontal direction is a horizontal distance dr.

As shown at the right side of FIG. 11B, at a reception side, a virtual reception antenna array having a shape similar to that of FIG. 11A may be formed.

In FIGS. 10 and 11, a virtual channel vector \vec{a}(ϕ) between a virtual reception antenna Rv0 among virtual reception antennas and Rv1 vertically spaced apart by Δ0 therefrom among virtual reception antennas may be expressed by Equation 6 below.

$$\vec{a} ( ϕ ) = [ \begin{matrix}{\vec{a}}_{0} ( ϕ ) \\ {\vec{a}}_{1} ( ϕ )\end{matrix} ] = [ \begin{matrix}1 \\ exp ( j 2 π d sin ϕ )\end{matrix} ] \qquad [ Equation 6 ]$$

Here, \vec{a}₀(ϕ) is a virtual channel vector of the virtual reception antenna Rv0, \vec{a}₁(ϕ) is a virtual channel vector of the virtual reception antenna Rv1, d is the vertical offset distance ΔO between the virtual reception antennas Rv0 and Rv, and φ is the phase of the signal.

In conclusion, the transceiver 200 of the radar device according to the present embodiment may form (Nt−1)*Nr virtual reception antennas or virtual channel vectors. As shown in FIGS. 10 and 11, in the radar device

according to the present embodiment, the transmission antenna or the reception antenna among the MIMO antennas may be offset in the vertical direction and different transmission signals may be used so as to acquire the azimuth information of the target as well as the vertical direction information such as an elevation angle or a height information.

Accordingly, by using the MIMO method, an antenna aperture can be increased by the formation of a virtual reception antenna, thereby improving the angular resolution of the radar device.

In addition, if a MIMO method including a vertical offset antenna is used, it is possible to estimate the vertical information of a target, for example, an elevation angle by virtually arranging antennas in a vertical direction.

As described above, the radar device and the angle compensation device according to the present embodiment can estimate the elevation angle of the target, similar to the description with reference to FIGS. 2 to 9, and therefore can determine the vertical misalignment of the radar device, and compensate an elevation angle of the target.

Specifically, the angle compensation device according to an embodiment of the present disclosure may obtain the elevation angle information or height information of a plurality of stationary objects while the vehicle is traveling in a straight line.

The angle compensation device according to an embodiment of the present disclosure may perform a linear regression analysis in which the elevation angles for a plurality of stationary objects are independent variables and the speed sensor error defined as a difference between a relative speed of the stationary object and the driving speed of the host vehicle is a dependent variable.

The angle compensation device according to an embodiment of the present disclosure may determine linear regression coefficients of the speed sensor errors for the estimated elevation angles of a plurality of stationary objects.

If the radar device is normally mounted in the vertical direction, the linear regression coefficient will be a value that converges to 0.

In the case that the radar device is mounted with a specific misalignment angle in the vertical direction, the linear regression coefficient may have a specific value other than 0.

Therefore, the angle compensation device according to an embodiment of the present disclosure may determine an elevation angle compensation value for compensating an elevation angle of the target based on an absolute value and sign of the linear regression coefficient, and may compensate the estimated elevation angle of the target based on the determination value.

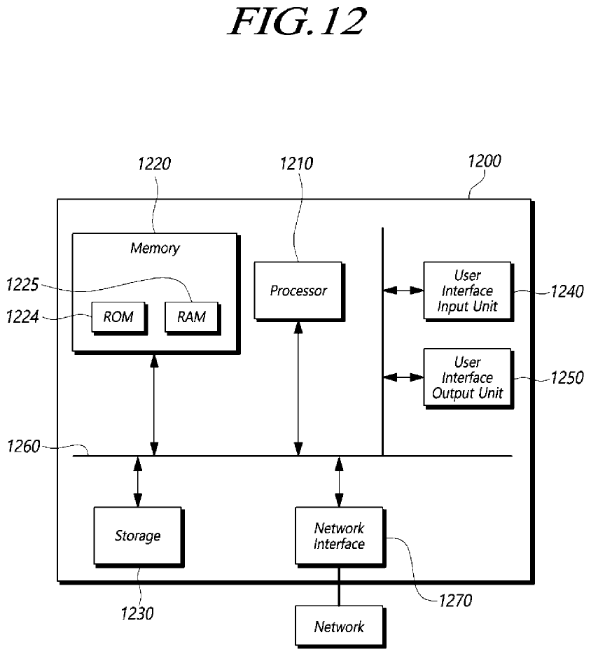

FIG. 12 illustrates a hardware configuration of a radar device or an angle compensation device included in the radar device according to an embodiment of the present disclosure.

Referring to FIG. 12, a radar device and the angle compensation device included in the radar device according to certain embodiments described above may be implemented with hardware or software implemented in a computer system or a controller.

For example, the transceiver 200, the signal processor 300 and the angle compensation device 400 of the radar device may be implemented as a computer device or a controller having hardware as shown in FIG. 12.

A computer system 1200 may be the radar device or system, the transceiver 200, and the signal processor 300 and the angle compensation device 400. The computer system 1200 may include one or more of one or more processors 1210, a memory 1220, a storage 1230, a user interface input unit 1240, and a user interface output unit 1250, and those elements may communicate with each other through a bus 1260.

In addition, the computer system 1200 may also include a network interface 1270 for connecting to a network. The processor 1210 may be a central processing unit (CPU) or a semiconductor device configured to execute processing instructions stored in the memory 1220 and/or the storage 1230. The memory 1220 and the storage 1330 may include various types of volatile and/or nonvolatile storage media. For example, the memory 1220 may include a read-only memory (ROM) 1224 and a random access memory (RAM) 1225.

In addition, one or more software modules performing functions of the stationary object detector 410, the straight line driving determiner 420, the relative speed determiner 430, the speed determiner 440, the linear regression analyzer 450 and the angle compensator 460 which are processed or performed in the angle compensation device may be installed in the computer system 1200.

Specifically, in the computer system 1200, a software module for determining a stationary object and determining whether the vehicle is traveling in a straight line, a software module for determining the relative speed of a stationary object and the speed of the host vehicle, a software module for performing a linear regression analysis of the speed sensor error with respect to the angle of the stationary object, a software module for determining an angle compensation value based on the determined linear regression coefficient and compensating for the estimated angle of the target.

The processor (e.g. main control unit (MCU)) 1210 of the radar apparatus according to the present embodiment may configured to execute the above-described software modules stored in the storage 1230 or the memory 1220 to perform a corresponding function.

As described above, according to some embodiments of the present disclosure, the radar device may determine the mounting misalignment of the radar device by analyzing the speed sensor error which may be determined by the difference between the relative speed of the stationary object measured by the radar device and the speed of the host vehicle according to a linear regression equation.

In addition, certain embodiments of the present disclosure may quickly and accurately compensate for the estimation angle of the target by determining an angle compensation value of the target according to a mounting misalignment angle of the radar device.

It should be noted that although all or some of the configurations or elements included in one or more of the embodiments described above have been combined to constitute a single configuration or component or operated in combination, the present disclosure is not necessarily limited thereto. That is, within the scope of the object or spirit of the present disclosure, all or some of the configurations or elements included in the one or more of the embodiments may be combined to constitute one or more configurations or components or operated in such combined configuration(s) or component(s). Further, each of the configurations or elements included in one or more of the embodiments may be implemented by an independent hardware configuration; some however, or all of the configurations or elements may be selectively combined and implemented by one or more computer program(s) having one or more program module(s) that perform some or all functions from one or more combined hardware configuration(s). Codes or code segments constituting the computer program(s) may be easily produced by those skilled in the art. As the computer programs stored in computer-readable media are read and executed by a computer, embodiments of the present disclosure can be implemented. The media for storing computer programs may include, for example, a magnetic storing medium, an optical recording medium, and a carrier wave medium.

Further, unless otherwise specified herein, terms ‘include’, ‘comprise’, ‘constitute’, ‘have’, and the like described herein mean that one or more other configurations or elements may be further included in a corresponding configuration or element. Unless otherwise defined herein, all the terms used herein including technical and scientific terms have the same meaning as those understood by those skilled in the art. The terms generally used such as those defined in dictionaries should be construed as being the same as the meanings in the context of the related art and should not be construed as being ideal or excessively formal meanings, unless otherwise defined herein.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A radar device comprising:
one or more processors; and
memory configured to store instructions which, when executed by the one or more processors, cause the one or more processors to perform operations comprising:
detect stationary objects;
determine whether a host vehicle is driving in a straight line;
determine a relative speed of each of the stationary objects with respect to the host vehicle;
determine a speed of the host vehicle by using a sensor of the host vehicle;
if the host vehicle is driving in the straight line, determine speed sensor errors by calculating a difference between the relative speed of each of the stationary objects with respect to the host vehicle and the speed of the host vehicle determined using the sensor, and determine a linear regression coefficient of the speed sensor errors for estimation angles of the stationary objects; and
determine an angle for compensating for misalignment of the radar device using the linear regression coefficient of the speed sensor errors and compensate an angle of a target using the angle determined using the linear regression coefficient of the speed sensor errors.

2. The radar device of claim 1, wherein the angle for compensating for the misalignment of the radar device is determined by the one or more processors if the one or more processors determine that an absolute value of the linear regression coefficient of the speed sensor errors for the estimation angles of the stationary objects is greater than or equal to a threshold value.

3. The radar device of claim 2, wherein the one or more processors are configured to determine the angle for compensating for the misalignment of the radar device differently depending on the absolute value and a sign of the linear regression coefficient of the speed sensor errors for the estimation angles of the stationary objects.

4. The radar device of claim 1, wherein the one or more processors are configured to determine the speed sensor errors for the estimation angles of the stationary objects by calculating a difference between an absolute value of a velocity component in a driving direction of the host vehicle among relative velocity vectors of the stationary objects and an absolute value of the speed of the host vehicle.

5. The radar device of claim 1, wherein the one or more processors are configured to determine a coefficient representing reliability of the linear regression coefficient, wherein the linear regression coefficient of the speed sensor errors for the estimation angles of the stationary objects is determined if the coefficient representing the reliability of the linear regression coefficient is equal to or greater than a threshold coefficient.

6. The radar device of claim 5, wherein the estimation angles of the stationary objects are estimated azimuths, and the angle for compensating for the misalignment of the radar device is a compensation value for the estimated azimuths of the target.

7. The radar device of claim 5, wherein the estimation angles of the stationary objects are estimated elevation angles, and the angle compensating for the misalignment of the radar device is a compensation value for the estimated elevation angles of the target.

8. The radar device of claim 1, wherein the one or more processors are configured to determine whether the host vehicle is driving in the straight line based on a yaw rate of the host vehicle and the speed of the host vehicle.

9. The radar device of claim 1, wherein the linear regression coefficient of the speed sensor errors for the estimation angles of the stationary objects is determined if a number of the detected stationary objects is equal to or greater than a threshold number.

10. An angle compensation method for a radar device, comprising:
determining whether a host vehicle drives in a straight line;
detecting stationary objects around the host vehicle;
determining a relative speed of each of the stationary objects with respect to the host vehicle;
determining a speed of the host vehicle by using a sensor of the host vehicle;
if the host vehicle is driving in the straight line, determining speed sensor errors by calculating a difference between the relative speed of each of the stationary objects with respect to the host vehicle and the speed of the host vehicle determined using the sensor;
determining a linear regression coefficient of the speed sensor errors for the estimation angles of the stationary objects; and
determining an angle for compensating for misalignment of the radar device using the linear regression coefficient of the speed sensor errors, and compensating an angle of a target using the angle determined using the linear regression coefficient of the speed sensor errors.

11. The angle compensation method of claim 10, wherein the determining of the angle for compensating for misalignment of the radar device is performed if an absolute value of the linear regression coefficient of the speed sensor errors for the estimation angles of the stationary objects is greater than or equal to a threshold value.

12. The angle compensation method of claim 11, wherein the determining of the angle for compensating for the misalignment of the radar device comprises determining the angle for compensating for the misalignment of the radar device differently depending on the absolute value and a sign of the linear regression coefficient of the speed sensor errors for the estimation angles of the stationary objects.

13. The angle compensation method of claim 10, wherein the speed sensor errors for the estimation angles of the stationary objects are determined by calculating a difference between an absolute value of a velocity component in a driving direction of the host vehicle among relative velocity vectors of the stationary objects and an absolute value of the speed of the host vehicle.

14. The angle compensation method of claim 10, further comprising determining a coefficient representing reliability of the linear regression coefficient,
wherein the determining of the linear regression coefficient of the speed sensor errors for the estimation angles of the stationary objects is performed if the coefficient representing the reliability of the linear regression coefficient is greater than or equal to a threshold coefficient.

15. The angle compensation method of claim 14, wherein the estimation angles of the stationary objects are estimated azimuths, and the angle for compensating for the misalignment of the radar device is a compensation value for the estimated azimuths of the target.

16. The angle compensation method of claim 14, wherein the estimation angles of the stationary objects are estimated elevation angles, and the angle compensating for the misalignment of the radar device is a compensation value for the estimated elevation angles of the target.

17. The angle compensation method of claim 10, wherein the determining of the linear regression coefficient of the speed sensor errors for the estimation angles of the stationary objects is performed if a number of the detected stationary objects is equal to or greater than a threshold number.

18. A radar device comprising:
an antenna unit including a transmission antenna unit including one or more transmission antennas and a reception antenna unit including one or more reception antennas;
a transceiver configured to transmit a transmission signal through the transmission antenna unit and receive a reception signal through the reception antenna unit;
one or more processors configured to:
estimate an angle of a target by processing the transmission signal and the reception signal; and
detect stationary objects around a host vehicle if the host vehicle is driving in a straight line, determine a relative speed of each of the stationary objects with respect to the host vehicle and a speed of the host vehicle, determine a linear regression coefficient of speed sensor errors by calculating a difference between the relative speed of each of the stationary objects and the speed of the host vehicle, determine an angle for compensating for misalignment of the radar device using the linear regression coefficient of the speed sensor errors, and compensate an angle of the target using the angle determined using the linear regression coefficient of the speed sensor errors.

19. The radar device of claim 18, wherein the one or more processors are configured to determine the angle for compensating for the misalignment of the radar device differently depending on a sign and an absolute value of the linear regression coefficient of the speed sensor errors for the estimation angles of the stationary objects.

20. The radar device of claim 18, wherein the one or more processors are configured to determine the speed sensor errors for the estimation angles of the stationary objects by calculating a difference between an absolute value of a velocity component in a driving direction of the host vehicle among relative velocity vectors of the stationary objects and an absolute value of the speed of the host vehicle.
